(19) United States
(12) Patent Application Publication
(10) Pub. No.: US 2004/0153989 A1
(43) Pub. Date: Aug. 5, 2004

(54) Pattern writing method capable of preventing or reducing an error between design dimensions and finished dimensions of a pattern

(75) Inventor: Koji Tange, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/430,292

(22) Filed: May 7, 2003

(30) Foreign Application Priority Data
Jan. 31, 2003 (JP) 2003-023057

(51) Int. Cl. G06F 17/50

(52) U.S. Cl. 716/19

(57) ABSTRACT

When a unit figure (F1) is divided by a provisional stripe boundary (C12) into a first portion (F1₁) and a second portion (F1₂), and besides, when width (W1) of the first portion (F1₁) is smaller than a predetermined threshold value (0.40 μm), the provisional stripe boundary (C12) is partly shifted in a position where the unit figure (F1) is described such that the first portion (F1₁) belongs to a provisional stripe region (R2). That is, provisional stripe regions (R1, R2) are corrected to obtain formal stripe regions (R1a, R2a). As a result, the unit figure (F1) belongs to the formal stripe region (R2a) as a whole. The writing section 3 then writes a pattern on a target of writing (6) based on pattern data (D2) in which the formal stripe regions (R1a, R2a) are defined.

### BACKGROUND OF THE INVENTION

1. Field of the Invention

The present invention relates to a pattern writing method.

2. Description of the Background Art

In an electron beam lithography system, the following steps are performed in the order presented: generating pattern data in which a layout of figures to be written is described; defining, in the pattern data, a plurality of stripe regions (also called “field regions”) separated by a stripe boundary, each having a predetermined stripe width; and writing the figures in each of the plurality of stripe regions based on the pattern data by means of electron beam scanning. In a conventional electron beam lithography system, a plurality of stripe regions are defined in parallel irrespective of a layout of figures described in pattern data. That is, all of stripe regions are defined linearly.

The technique relating to such electron beam lithography system is disclosed in, for example, Japanese Patent Application Laid-Open Nos. 2001-7018 and 1-297823 (1989).

However, according to the conventional electron beam lithography system, when an arbitrary figure is divided into a first portion belonging to a first stripe region and a second portion belonging to a second stripe region and when a size of the first portion in the direction of a stripe width is smaller than a predetermined threshold value, an error between design dimensions and finished dimensions of a pattern of the arbitrary figure disadvantageously increases.

### SUMMARY OF THE INVENTION

It is an object of the present invention to provide a pattern writing method capable of preventing or reducing an error between design dimensions and finished dimensions of a pattern.

According to a first aspect of the present invention, the pattern writing method includes the following steps (a) to (c). The step (a) is to generate pattern data in which a layout of a figure to be written is described. The step (b) is to define, in the pattern data, a plurality of stripe regions divided by a stripe boundary, each of the plurality of stripe regions having a predetermined stripe width. The step (c) is to write the figure on a target of writing in each of the plurality of stripe regions based on the pattern data. The plurality of stripe regions include a first stripe region and a second stripe region adjacent to each other. In the step (b), when a unit figure is divided into a first portion belonging to the first stripe region and a second portion belonging to the second stripe region, and when a size of the first portion in the direction of the stripe width is smaller than a predetermined threshold value, the stripe boundary between the first and second stripe regions is partly shifted in a position where the unit figure is described.

An error between finished dimensions and design dimensions can be prevented or reduced.

According to a second aspect of the present invention, the pattern writing method includes the following steps (a) to (c). The step (a) is to generate pattern data in which a layout of a figure to be written is described. The step (b) is to define, in the pattern data, a plurality of stripe regions divided by a stripe boundary. The step (c) is to write the figure on a target of writing in each of the plurality of stripe regions based on the pattern data. The plurality of stripe regions include a first stripe region and a second stripe region adjacent to each other. In the step (b), when a unit figure is divided into a first portion belonging to the first stripe region and a second portion belonging to the second stripe region, and when a size of the first portion in the direction of a stripe width is smaller than a predetermined threshold value, a stripe width of the second stripe region is increased in a position where the unit figure is described, whereby the first portion belongs to the second stripe region.

An error between finished dimensions and design dimensions can be prevented or reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the configuration of an electron beam lithography system according to a first preferred embodiment of the present invention;

FIG. 2 is a block diagram illustrating the configuration of a stripe region defining section;

FIG. 3 is a flow chart illustrating the process flow in a pattern data generating section and the stripe region defining section;

FIGS. 4 and 5 are schematic views each illustrating an example of pattern data;

FIG. 6 is a graph plotting the result of search of the relationship between width and error;

FIG. 7 is a schematic view illustrating a first example of pattern data;

FIG. 8 is a schematic view illustrating a second example of pattern data; and

FIG. 9 is a schematic view illustrating a third example of pattern data.

### DESCRIPTION OF THE PREFERRED EMBODIMENTS

Hereinafter, preferred embodiments of a pattern writing method according to the present invention will be specifically described referring to, by way of example, an electron beam lithography system of raster scan and continuous stage movement type.

First Preferred Embodiment

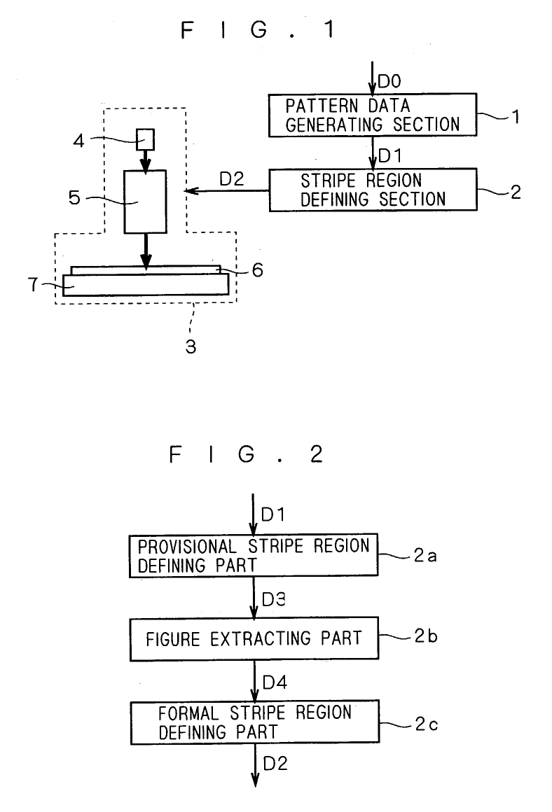

FIG. 1 is a block diagram illustrating an electron beam lithography system according to a first preferred embodiment of the present invention. As shown in FIG. 1, the electron beam lithography system includes a pattern data generating section 1, a stripe region defining section 2 and a writing section 3. The writing section 3 includes an electron gun 4 for emitting electron beam, an optical system 5 for controlling electron beam emitted from the electron gun 4 and an XY stage 7 on which a target of writing 6 is mounted. When the electron beam lithography system is used for photomask fabrication, the target 6 has the structure in which a glass substrate, a light shielding film and EB resist are laminated in this order and is mounted on the XY stage 7 with the EB resist facing the optical system 5.

FIG. 2 is a block diagram illustrating the configuration of the stripe region defining section 2. The section 2 includes a provisional stripe region defining part 2a, a figure extracting part 2b and a formal stripe region defining part 2c.

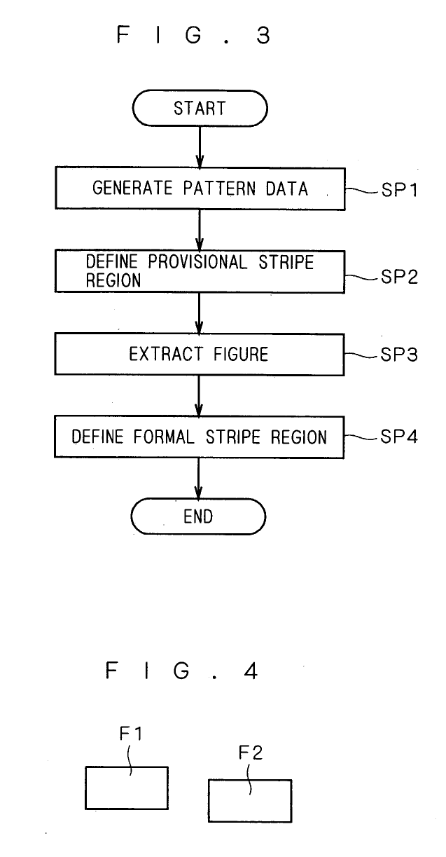

FIG. 3 is a flow chart illustrating the process flow in the pattern data generating section 1 and stripe region defining section 2. Hereinbelow, the operations of the pattern data generating section 1 and stripe region defining section 2 will be described referring to FIGS. 1 to 3.

First, in step SP1 shown in FIG. 3, the pattern data generating section 1 shown in FIG. 1 obtains design data D0 generated by CAD or the like and extracts figures to be written on the target 6 from the design data D0, thereby generating pattern data D1 in which a layout of the figures is described. FIG. 4 is a schematic view illustrating an example of the pattern data D1. In the pattern data D1, unit figures F1 and F2 are described. The pattern data D1 is inputted to the provisional stripe region defining part 2a shown in FIG. 2.

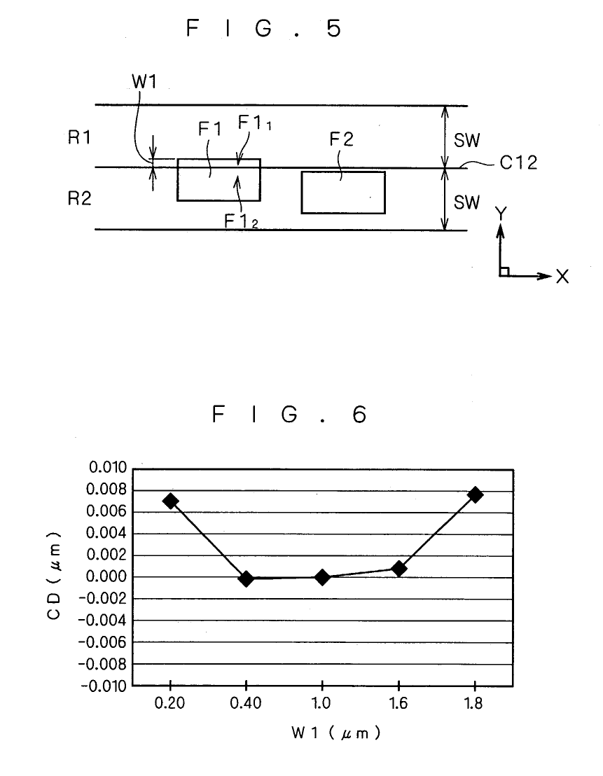

Next, in step SP2 shown in FIG. 3, the provisional stripe region defining part 2a shown in FIG. 2 defines a provisional stripe region in the pattern data D1 to generate pattern data D3. FIG. 5 is a schematic view illustrating an example of the pattern data D3. In FIG. 5, the direction X is a lengthwise direction of provisional stripe regions R1 and R2 and the direction Y is a widthwise direction of the regions R1 and R2. Being separated by a provisional stripe boundary C12 linearly extending in the direction X, the provisional stripe regions R1 and R2 extending in the direction X are defined in parallel to each other. The provisional stripe regions R1 and R2 each have such a predetermined stripe width SW that allows electron beam to be deflected in the direction Y by the optical system 5 shown in FIG. 1. The figures F1 and F2 each have a width (i.e., size in the direction Y) of, for example, 2.0 μm. In the electron beam lithography system according to the present embodiment, the writing grid size (address size) is 0.20 μm.

According to the example shown in FIG. 5, the figure F1 has a first portion F1₁ belonging to the provisional stripe region R1 and a second portion F1₂ belonging to the provisional stripe region R2. The first portion F1₁ has a width W1 (i.e., size in the direction Y) of 0.20 μm. The figure F2 belongs to the provisional stripe region R2 as a whole.

FIG. 6 is a graph plotting the relationship between the width W1 and error CD when the width of the figure F1 is fixed to 2.0 μm. The error CD is obtained by subtracting design dimensions (20.0 μm in this case) from finished dimensions of the figure F1 with respect to the direction Y. FIG. 6 shows that the error CD increases in the range where the width W1 is smaller than 0.40 μm and wider than 1.6 μm. That is, it is shown that, in the case where the figure F1 is divided by the provisional stripe boundary C12 into two portions, the error CD increases when a narrower one of the portions has a width smaller than 0.40 μm. As a result, a threshold value which will be described later is set at 0.40 μm.

In the example shown in FIG. 5, the width W1 is 0.20 μm. Thus, writing the figures F1 and F2 on the target 6 based on the pattern data D3 will cause an increase in an error between design dimensions and finished dimensions of the figure F1.

Then, next, in step SP3 shown in FIG. 3, the figure extracting part 2b shown in FIG. 2 extracts one or more figures that satisfy both the following conditions RA and RB from among a plurality of figures described in the pattern data D3.

Condition RA: A figure should lie across a plurality of provisional stripe regions. That is, the figure should be divided by a provisional stripe boundary into a plurality of portions.

Condition RB: The above-described plurality of portions should include a portion whose size in the direction Y is smaller than a threshold value (0.40 μm).

In the example shown in FIG. 5, the figure F1 is divided by the provisional stripe boundary C12 into the first portion F1₁ and second portion F1₂, which satisfies the condition RA. The size of the first portion F11 in the direction Y is 0.20 μm, smaller than the threshold value (0.40 μm), which satisfies the condition RB. Thus, the figure F1 is extracted by the figure extracting part 2b in the step SP3. On the other hand, the figure F2 does not satisfy the conditions RA and RB, which is thus not extracted by the figure extracting part 2b. Information on the figure F1 extracted by the figure extracting part 2b is inputted to the formal stripe region defining part 2c shown in FIG. 2 together with the pattern data D3.

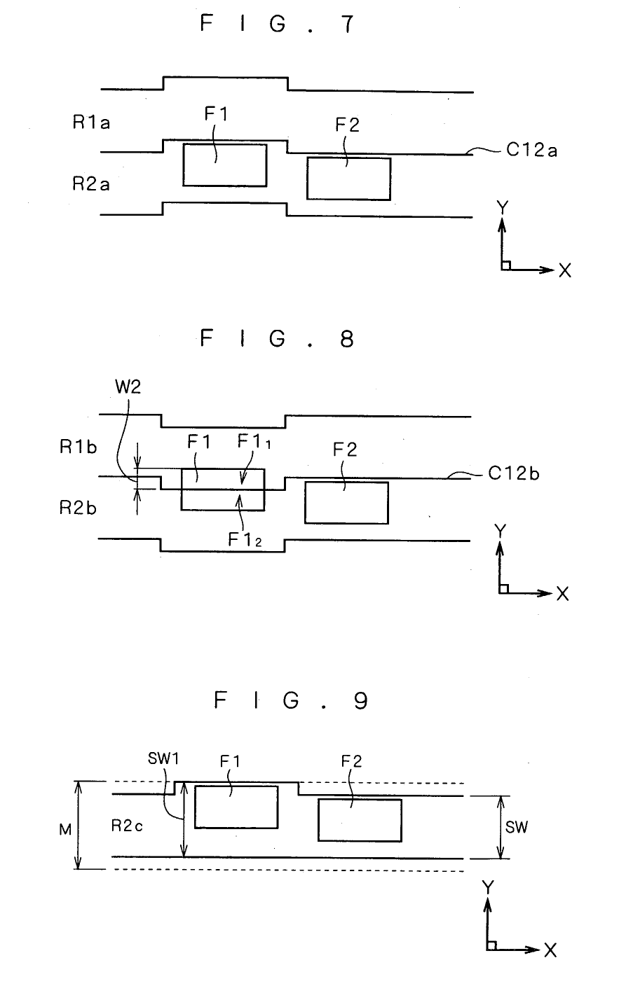

Next, in step SP4 shown in FIG. 3, the formal stripe region defining part 2c shown in FIG. 2 corrects the pattern data D3 to generate the pattern data D2. Specifically, the part 2c partly shifts the provisional stripe boundary C12 toward the provisional stripe region R1 in a position where the figure F1 is described such that the first portion F1₁ belongs to the provisional stripe region R2. FIG. 7 is a schematic view illustrating a first example of the pattern data D2. Formal stripe regions R1a, R2a obtained by correcting the provisional stripe regions R1, R2 and formal stripe boundary Cl2a obtained by correcting the provisional stripe boundary Cl2 are defined in the pattern data D2. In the pattern data D2, the figures F1 and F2 both belong to the formal stripe region R2a as a whole.

In the electron beam lithography system according to the present embodiment, the writing grid size is 0.20 μm. Therefore, the pattern data D3 is not corrected when the width W1 of the first portion F1₁ is twice the writing grid size, but is corrected when the width W1 is equal to the writing grid size. That is, the condition RB may be rewritten as follows:

Condition RB: The above-described plurality of portions should include a portion whose size in the direction Y is equal to the writing grid size.

When the pattern data D3 does not include a figure satisfying both the conditions RA and RB, the pattern data D3 is the pattern data D2 without any correction.

Referring back to FIG. 1, the pattern data D2 is inputted to the writing section 3. The writing section 3 writes a pattern on the target 6 in each of the formal stripe regions R1a and R2a while moving the XY stage 7 in accordance with the shape of the formal stripe regions R1a and R2a based on the pattern data D2. As shown in FIG. 7, the formal stripe regions R1a and R2a both have projections and depressions, the XY stage 7 is moved in the direction Y as well as in the direction X in the writing step in each of the formal stripe regions R1a and R2a.

In the example shown in FIG. 7, neither figure belongs to the formal stripe region R1a. Thus, the electron gun 4 is always turned off with respect to the formal stripe region R1a. Since the figures F1 and F2 belong to the formal stripe region R2a, the electron gun 4 is turned on, with respect to the formal stripe region R2a, in correspondence with the position where the figures F1 and F2 are described. Electron beam emitted from the electron gun 4 is deflected by the optical system 5 in the direction Y, whereby the figures F1 and F2 are written on the target 6.

As has been described, according to the electron beam writing method of the present embodiment, when the unit figure F1 is divided by the provisional stripe boundary C12 into the first portion F1₁ and second portion F1₂, and besides, when the width W1 of the first portion F1 is smaller than a predetermined threshold value (0.401 μm), the provisional stripe boundary C12 is partly shifted in a position where the figure F1 is described such that the first portion F1 belongs to the provisional stripe region R2. That is, the provisional stripe regions R1 and R2 are corrected to obtain the formal stripe regions R1a and R2a, whereby the figure F1 belongs to the formal stripe region R2a as a whole. The writing section 3 writes a pattern on the target 6 based on the pattern data D2 in which the formal stripe regions R1a and R2a are defined. This makes it possible to prevent or reduce an error generated between finished dimensions and design dimensions of the figure F1.

Second Preferred Embodiment

In the step SP4 shown in FIG. 3, the formal stripe region defining part 2c corrects the pattern data D3 to generate the pattern data D2. Here, the part 2c may generate a different type of pattern data D2 than in the first preferred embodiment.

Specifically, the formal stripe region defining part 2c partly shifts the provisional stripe boundary C12 toward the provisional stripe region R2 in a position where the figure F1 is described such that the width W1 of the first portion F1₁ is equal to or greater than a threshold value (0.40 μm). FIG. 8 is a schematic view illustrating a second example of the pattern data D2. Defined in the pattern data D2 are formal stripe regions R1b, R2b obtained by correcting the provisional stripe regions R1, R2 and formal stripe boundary Cl2b obtained by correcting the provisional stripe boundary C12. In the pattern data D2, the figure F1 is divided by the formal stripe boundary C12b into the first portion F1 belonging to the formal stripe region R1b and the second portion F1₂ belonging to the formal stripe region R2b. The first portion F1₁ has a width W2 of, for example, 1.0 μm, greater than a threshold value (0.40 μm).

As described, with the method of the present embodiment, when the unit figure F1 is divided by the provisional stripe boundary C12 into the first portion F1₁ and second portion F1₂, and besides, when the width W1 of the first portion F1₁ is smaller than a predetermined threshold value (0.40 μm), the provisional stripe boundary C12 is partly shifted in a position where the figure F1 is described such that the width W1 becomes equal to or greater than the threshold value. That is, the provisional stripe regions R1 and R2 are corrected to thereby obtain the formal stripe regions R1b and R2b. As a result, the width W1 becomes equal to or greater than the threshold value. Then, the writing section 3 writes a pattern on the target 6 based on the pattern data D2 in which the formal stripe regions R1b and R2b are defined. This makes it possible to prevent or reduce an error generated between finished dimensions and design dimensions of the figure F1.

Third Preferred Embodiment

In step SP4 shown in FIG. 3, the formal stripe region defining part 2c corrects the pattern data D3 to generate the pattern data D2. Here, the part 2c may generate a different type of pattern data D2 than in the first and second preferred embodiments.

FIG. 9 is a schematic view illustrating a third example of the pattern data D2. Width M is the maximum width that allows electron beam to be deflected in the direction Y by the optical system 5 shown in FIG. 1. A stripe width SW is smaller than the maximum width M. With an electron beam writing method according to the present embodiment, the formal stripe region defining part 2c increases the stripe width of the provisional stripe region R2 in a position where the figure F1 is described such that the first portion F1₁ belongs to the provisional stripe region R2. In FIG. 9, a stripe width SW1 in the position where the figure F1 is described is greater than the stripe width SW in other positions. As a result, the figures F1 and F2 both belong to a formal stripe region R2c as a whole.

Referring back to FIG. 1, the pattern data D2 is inputted to the writing section 3. The writing section 3 writes a pattern on the target 6 based on the pattern data D2. With the method of the present embodiment, in a writing step with respect to the formal stripe region R2c, the XY stage 7 is not moved in the direction Y, but the optical system 5 controls a deflection width of electron beam in a variable manner.

As described, with the method of the present embodiment, when the unit figure F1 is divided by the provisional stripe boundary C12 into the first portion F1₁ and the second portion F1₂, and besides, when the width W1 of the first portion F1₁ is smaller than a predetermined threshold value (0.401 μm), the stripe width of the provisional stripe region R2 in the position where the figure F1 is described is increased. Thus, the first portion F1₁ belongs to the provisional stripe region R2, which can prevent or reduce an error generated between finished dimensions and design dimensions of the figure F1.

In a lithography step which is one of manufacturing steps of a semiconductor device, reduction projection exposure is performed on photoresist formed on a semiconductor substrate using a photomask fabricated by an electron beam lithography system with exposure light such as KrF excimer laser beam. However, writing may be performed directly on EB resist formed on a semiconductor substrate without using any photomask. In this case, the target 6 shown in FIG. 1 is the EB resist formed on the semiconductor substrate.

While the invention has been shown and described in detail, the foregoing description is in all aspects illustrative and not restrictive. It is therefore understood that numerous modifications and variations can be devised without departing from the scope of the invention.

What is claimed is:

1. A pattern writing method comprising the steps of:
(a) generating pattern data in which a layout of a figure to be written is described;
(b) defining, in said pattern data, a plurality of stripe regions divided by a stripe boundary, each of said plurality of stripe regions having a predetermined stripe width; and
(c) writing said figure on a target of writing in each of said plurality of stripe regions based on said pattern data, wherein
said plurality of stripe regions include a first stripe region and a second stripe region adjacent to each other, and
in said step (b), when a unit figure is divided into a first portion belonging to said first stripe region and a second portion belonging to said second stripe region, and when a size of said first portion in the direction of said stripe width is smaller than a predetermined threshold value, said stripe boundary between said first and second stripe regions is partly shifted in a position where said unit figure is described.

2. The pattern writing method according to claim 1, wherein
in said step (b), said stripe boundary between said first and second stripe regions is shifted toward said first stripe region, whereby said first portion belongs to said second stripe region.

3. The pattern writing method according to claim 1, wherein
in said step (b), said stripe boundary between said first and second stripe regions is shifted toward said second stripe region, whereby said size is equal to or greater than said threshold value.

4. The pattern writing method according to claim 1, wherein
said threshold value is 0.40 μm.

5. A pattern writing method comprising the steps of:
(a) generating pattern data in which a layout of a figure to be written is described;
(b) defining, in said pattern data, a plurality of stripe regions divided by a stripe boundary; and
(c) writing said figure on a target of writing in each of said plurality of stripe regions based on said pattern data, wherein
said plurality of stripe regions include a first stripe region and a second stripe region adjacent to each other, and
in said step (b), when a unit figure is divided into a first portion belonging to said first stripe region and a second portion belonging to said second stripe region, and when a size of said first portion in the direction of a stripe width is smaller than a predetermined threshold value, a stripe width of said second stripe region is increased in a position where said unit figure is described, whereby said first portion belongs to said second stripe region.

6. The pattern writing method according to claim 5, wherein
said threshold value is 0.40 μm.
